(19) United States
(12) Patent Application Publication
(10) Pub. No.: US 2022/0358485 A1
(43) Pub. Date: Nov. 10, 2022

(54) METHOD, SYSTEM, AND COMPUTER PROGRAM PRODUCT FOR PROCESSING A GIFT CARD

(71) Applicant: Visa International Service Association, San Francisco, CA (US)

(72) Inventors: Gurpreet Singh Bhasin, Fremont, CA (US); Ankush Singhal, Dublin, CA (US)

(21) Appl. No.: 17/621,263

(22) PCT Filed: Jul. 2, 2019
(86) PCT No.: PCT/US2019/040310

§ 371 Date: Dec. 21, 2021

(51) Int. Cl. G06Q 20/34; G06Q 20/38; G06Q 20/40

(52) U.S. Cl. CPC G06Q 20/342; G06Q 20/346; G06Q 20/387; G06Q 20/405

(57) ABSTRACT

A method of processing a gift card includes: receiving a registration request for registration of a gift card, the registration request including an identifier associated with at least one gift card user; registering a gift card for a gift card amount, the gift card having an expiration date; monitoring redemption of the gift card amount by at least determining whether at least a portion of the gift card amount has not been redeemed by the expiration date; and causing at least a portion of the gift card amount to be transferred to an account in an electronic gift card wallet associated with the at least one gift card user based on the identifier associated with the at least one gift card user. A system and computer program product for processing a gift card are also disclosed.

### CROSS-REFERENCE TO RELATED APPLICATION

This application is the United States national phase of International Application No. PCT/US2019/040310 filed Jul. 2, 2019, the entire disclosure of which is hereby incorporated in its entirety.

### BACKGROUND

### 1. Technical Field

The disclosure relates to processing of gift cards and, in some non-limiting embodiments or aspects, to a method, system, and computer program product for processing gift cards.

### 2. Technical Considerations

Gift cards are a popular gift which allow the recipient to more flexibly purchase goods or services at a given merchant(s). It is estimated that consumers spend approximately $130 billion in gift cards each year. However, of this amount, nearly $1 billion go unspent every year¹. ¹https://www.marketwatch.com/story/1-billion-in-gift-cards-go-unused-every-year-heres-how-to-avoid-that-2016-12-30

For example, gift cards may go unspent by being lost, expiring, or by being associated with a merchant(s) with whom the recipient does not shop. Therefore, an inefficiency exists in processing gift cards, which adversely affects consumers holding gift cards.

### SUMMARY

Accordingly, and generally, provided is an improved method, system, and computer program product for processing gift cards.

According to some non-limiting embodiments or aspects, a method of processing a gift card includes: receiving, with at least one processor, a registration request for registration of a gift card, the registration request including an identifier associated with at least one gift card user; in response to the registration request, registering, with at least one processor, a gift card for a gift card amount, the gift card including an expiration date; monitoring, with at least one processor, redemption of the gift card amount by at least determining whether at least a portion of the gift card amount has not been redeemed by the expiration date; and in response to determining that at least a portion of the gift card amount has not been redeemed by the expiration date, causing, with at least one processor, at least a portion of the gift card amount to be transferred to an account in an electronic gift card wallet associated with the at least one gift card user based on the identifier associated with the at least one gift card user.

In some non-limiting embodiments or aspects, the method may further include receiving, with at least one processor, a gift card transfer request, where the gift card transfer request causes the identifier associated with the at least one gift card user to be updated. The gift card may be associated with a first merchant, where the first merchant is associated with a merchant community including a plurality of merchants. The method may further include receiving, with at least one processor, a transaction request for a transaction associated with a transaction amount, where the transaction request is initiated by the electronic gift card wallet, where the transaction request causes application of at least a portion of the gift card amount transferred to the electronic gift card wallet account toward the transaction amount. The transaction may involve a merchant of the plurality of merchants from the merchant community. The transaction may involve a merchant different from the first merchant.

In some non-limiting embodiments or aspects, monitoring redemption of the gift card amount may further include determining at some time before the expiration date whether at least a portion of the gift card amount has not been redeemed; and in response to determining that at least a portion of the gift card amount has not been redeemed, communicating a reminder message to a computing device associated with the at least one gift card user based on the identifier associated with the at least one gift card user. The at least one gift card user may be at least one of a purchaser of the gift card and a recipient of the gift card. The method may further include receiving, with at least one processor, a transfer request, where the transfer request is initiated by the electronic gift card wallet, where the transfer request causes transfer of at least a portion of the gift card amount transferred to the electronic gift card wallet account to a bank account associated with the at least one gift card user. The registration request may be initiated by the electronic gift card wallet.

According to some non-limiting embodiments or aspects, a system for processing a gift card includes at least one processor programmed or configured to receive a registration request for registration of a gift card, the registration request including an identifier associated with at least one gift card user; in response to the registration request, register a gift card for a gift card amount, the gift card including an expiration date; monitor redemption of the gift card amount by at least determining whether at least a portion of the gift card amount has not been redeemed by the expiration date; and in response to determining that at least a portion of the gift card amount has not been redeemed by the expiration date, cause at least a portion of the gift card amount to be transferred to an account in an electronic gift card wallet associated with the at least one gift card user based on the identifier associated with the at least one gift card user.

In some non-limiting embodiments or aspects, the at least one processor may be further programmed or configured to receive a gift card transfer request, where the gift card transfer request causes the identifier associated with the at least one gift card user to be updated. The gift card may be associated with a first merchant, where the first merchant is associated with a merchant community including a plurality of merchants. The at least one processor may be further programmed or configured to receive a transaction request for a transaction associated with a transaction amount, where the transaction request is initiated by the electronic gift card wallet, where the transaction request causes application of at least a portion of the gift card amount transferred to the electronic gift card wallet account toward the transaction amount. The transaction may involve a merchant of the plurality of merchants from the merchant community. The transaction may involve a merchant different from the first merchant.

In some non-limiting embodiments or aspects, monitoring redemption of the gift card amount may further include determining at some time before the expiration date whether at least a portion of the gift card amount has not been redeemed; and in response to determining that at least a portion of the gift card amount has not been redeemed, communicating a reminder message to a computing device associated with the at least one gift card user based on the identifier associated with the at least one gift card user. The at least one gift card user may be at least one of a purchaser of the gift card and a recipient of the gift card. The at least one processor may be further programmed or configured to receive a transfer request, where the transfer request is initiated by the electronic gift card wallet, where the transfer request causes transfer of at least a portion of the gift card amount transferred to the electronic gift card wallet account to a bank account associated with the at least one gift card user. The registration request may be initiated by the electronic gift card wallet.

According to some non-limiting embodiments or aspects, a computer program product for processing a gift card includes at least one non-transitory computer-readable medium including one or more instructions that, when executed by at least one processor, cause the at least one processor to: receive a registration request for registration of a gift card, the registration request including an identifier associated with at least one gift card user; in response to the registration request, register a gift card for a gift card amount, the gift card including an expiration date; monitor redemption of the gift card amount by at least determining whether at least a portion of the gift card amount has not been redeemed by the expiration date; and in response to determining that at least a portion of the gift card amount has not been redeemed by the expiration date, cause at least a portion of the gift card amount to be transferred to an account in an electronic gift card wallet associated with the at least one gift card user based on the identifier associated with the at least one gift card user.

In some non-limiting embodiments or aspects, the one or more instructions may cause the at least one processor to receive a gift card transfer request, where the gift card transfer request causes the identifier associated with the at least one gift card user to be updated. The gift card may be associated with a first merchant, where the first merchant is associated with a merchant community including a plurality of merchants. The one or more instructions may cause the at least one processor to receive a transaction request for a transaction associated with a transaction amount, where the transaction request is initiated by the electronic gift card wallet, where the transaction request causes application of at least a portion of the gift card amount transferred to the electronic gift card wallet account toward the transaction amount. The transaction may involve a merchant of the plurality of merchants from the merchant community. The transaction may involve a merchant different from the first merchant.

In some non-limiting embodiments or aspects, monitoring redemption of the gift card amount may further include determining at some time before the expiration date whether at least a portion of the gift card amount has not been redeemed; and in response to determining that at least a portion of the gift card amount has not been redeemed, communicating a reminder message to a computing device associated with the at least one gift card user based on the identifier associated with the at least one gift card user. The at least one gift card user may be at least one of a purchaser of the gift card and a recipient of the gift card. The one or more instructions may cause the at least one processor to receive a transfer request, where the transfer request is initiated by the electronic gift card wallet, where the transfer request causes transfer of at least a portion of the gift card amount transferred to the electronic gift card wallet account to a bank account associated with the at least one gift card user. The registration request may be initiated by the electronic gift card wallet.

Further non-limiting embodiments or aspects are set forth in the following numbered clauses:

Clause 1: A method of processing a gift card, comprising: receiving, with at least one processor, a registration request for registration of a gift card, the registration request comprising an identifier associated with at least one gift card user; in response to the registration request, registering, with at least one processor, a gift card for a gift card amount, the gift card comprising an expiration date; monitoring, with at least one processor, redemption of the gift card amount by at least determining whether at least a portion of the gift card amount has not been redeemed by the expiration date; and in response to determining that at least a portion of the gift card amount has not been redeemed by the expiration date, causing, with at least one processor, at least a portion of the gift card amount to be transferred to an account in an electronic gift card wallet associated with the at least one gift card user based on the identifier associated with the at least one gift card user.

Clause 2: The method of clause 1, further comprising: receiving, with at least one processor, a gift card transfer request, wherein the gift card transfer request causes the identifier associated with the at least one gift card user to be updated.

Clause 3: The method of clause 1 or 2, wherein the gift card is associated with a first merchant, wherein the first merchant is associated with a merchant community comprising a plurality of merchants.

Clause 4: The method of any of clauses 1-3, further comprising: receiving, with at least one processor, a transaction request for a transaction associated with a transaction amount, wherein the transaction request is initiated by the electronic gift card wallet, wherein the transaction request causes application of at least a portion of the gift card amount transferred to the electronic gift card wallet account toward the transaction amount.

Clause 5: The method of any of clauses 1-4, wherein the transaction involves a merchant of the plurality of merchants from the merchant community.

Clause 6: The method of any of clauses 1-5, wherein the transaction involves a merchant different from the first merchant.

Clause 7: The method of any of clauses 1-6, wherein monitoring redemption of the gift card amount further comprises: determining at some time before the expiration date whether at least a portion of the gift card amount has not been redeemed; and in response to determining that at least a portion of the gift card amount has not been redeemed, communicating a reminder message to a computing device associated with the at least one gift card user based on the identifier associated with the at least one gift card user.

Clause 8: The method of any of clauses 1-7, wherein the at least one gift card user is at least one of a purchaser of the gift card and a recipient of the gift card.

Clause 9: The method of any of clauses 1-8, further comprising: receiving, with at least one processor, a transfer request, wherein the transfer request is initiated by the electronic gift card wallet, wherein the transfer request causes transfer of at least a portion of the gift card amount transferred to the electronic gift card wallet account to a bank account associated with the at least one gift card user.

Clause 10: The method of any of clauses 1-9, wherein the registration request is initiated by the electronic gift card wallet.

Clause 11: A system for processing a gift card, comprising at least one processor programmed or configured to: receive a registration request for registration of a gift card, the registration request comprising an identifier associated with at least one gift card user; in response to the registration request, register a gift card for a gift card amount, the gift card comprising an expiration date; monitor redemption of the gift card amount by at least determining whether at least a portion of the gift card amount has not been redeemed by the expiration date; and in response to determining that at least a portion of the gift card amount has not been redeemed by the expiration date, cause at least a portion of the gift card amount to be transferred to an account in an electronic gift card wallet associated with the at least one gift card user based on the identifier associated with the at least one gift card user.

Clause 12: The system of clause 11, wherein the at least one processor is further programmed or configured to: receive a gift card transfer request, wherein the gift card transfer request causes the identifier associated with the at least one gift card user to be updated.

Clause 13: The system of clause 11 or 12, wherein the gift card is associated with a first merchant, wherein the first merchant is associated with a merchant community comprising a plurality of merchants.

Clause 14: The system of any of clauses 11-13, wherein the at least one processor is further programmed or configured to: receive a transaction request for a transaction associated with a transaction amount, wherein the transaction request is initiated by the electronic gift card wallet, wherein the transaction request causes application of at least a portion of the gift card amount transferred to the electronic gift card wallet account toward the transaction amount.

Clause 15: The system of any of clauses 11-14, wherein the transaction involves a merchant of the plurality of merchants from the merchant community.

Clause 16: The system of any of clauses 11-15, wherein the transaction involves a merchant different from the first merchant.

Clause 17: The system of any of clauses 11-16, wherein monitoring redemption of the gift card amount further comprises: determining at some time before the expiration date whether at least a portion of the gift card amount has not been redeemed; and in response to determining that at least a portion of the gift card amount has not been redeemed, communicating a reminder message to a computing device associated with the at least one gift card user based on the identifier associated with the at least one gift card user.

Clause 18: The system of any of clauses 11-17, wherein the at least one gift card user is at least one of a purchaser of the gift card and a recipient of the gift card.

Clause 19: The system of any of clauses 11-18, wherein the at least one processor is further programmed or configured to: receive a transfer request, wherein the transfer request is initiated by the electronic gift card wallet, wherein the transfer request causes transfer of at least a portion of the gift card amount transferred to the electronic gift card wallet account to a bank account associated with the at least one gift card user.

Clause 20: The system of any of clauses 11-19, wherein the registration request is initiated by the electronic gift card wallet.

Clause 21: A computer program product for processing a gift card, the computer program product comprising at least one non-transitory computer-readable medium including one or more instructions that, when executed by at least one processor, cause the at least one processor to: receive a registration request for registration of a gift card, the registration request comprising an identifier associated with at least one gift card user; in response to the registration request, register a gift card for a gift card amount, the gift card comprising an expiration date; monitor redemption of the gift card amount by at least determining whether at least a portion of the gift card amount has not been redeemed by the expiration date; and in response to determining that at least a portion of the gift card amount has not been redeemed by the expiration date, cause at least a portion of the gift card amount to be transferred to an account in an electronic gift card wallet associated with the at least one gift card user based on the identifier associated with the at least one gift card user.

Clause 22: The computer program product of clause 21, wherein the one or more instructions cause the at least one processor to: receive a gift card transfer request, wherein the gift card transfer request causes the identifier associated with the at least one gift card user to be updated.

Clause 23: The computer program product of clause 21 or 22, wherein the gift card is associated with a first merchant, wherein the first merchant is associated with a merchant community comprising a plurality of merchants.

Clause 24: The computer program product of any of clauses 21-23, wherein the one or more instructions cause the at least one processor to: receive a transaction request for a transaction associated with a transaction amount, wherein the transaction request is initiated by the electronic gift card wallet, wherein the transaction request causes application of at least a portion of the gift card amount transferred to the electronic gift card wallet account toward the transaction amount.

Clause 25: The computer program product of any of clauses 21-24, wherein the transaction involves a merchant of the plurality of merchants from the merchant community.

Clause 26: The computer program product of any of clauses 21-25, wherein the transaction involves a merchant different from the first merchant.

Clause 27: The computer program product of any of clauses 21-26, wherein monitoring redemption of the gift card amount further comprises: determining at some time before the expiration date whether at least a portion of the gift card amount has not been redeemed; and in response to determining that at least a portion of the gift card amount has not been redeemed, communicating a reminder message to a computing device associated with the at least one gift card user based on the identifier associated with the at least one gift card user.

Clause 28: The computer program product of any of clauses 21-27, wherein the at least one gift card user is at least one of a purchaser of the gift card and a recipient of the gift card.

Clause 29: The computer program product of any of clauses 21-28, wherein the one or more instructions cause the at least one processor to: receive a transfer request, wherein the transfer request is initiated by the electronic gift card wallet, wherein the transfer request causes transfer of at least a portion of the gift card amount transferred to the electronic gift card wallet account to a bank account associated with the at least one gift card user.

Clause 30: The computer program product of any of clauses 21-29, wherein the registration request is initiated by the electronic gift card wallet.

These and other features and characteristics of the present disclosure, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the disclosure. As used in the specification and the claims, the singular form of “a,” “an,” and “the” include plural referents unless the context clearly dictates otherwise. Further, the phrase “based on” is intended to mean “based at least partially on” unless explicitly stated otherwise.

### BRIEF DESCRIPTION OF THE DRAWINGS

Additional advantages and details of the disclosure are explained in greater detail below with reference to the non-limiting exemplary embodiments that are illustrated in the accompanying schematic figures, in which:

FIG. 1 shows an existing system for processing a gift card;

FIG. 2 shows a system for processing a gift card according to some non-limiting embodiments or aspects;

FIG. 3 shows a user interface for registering a gift card according to some non-limiting embodiments or aspects;

FIG. 4 shows a user interface for displaying active gift cards according to some non-limiting embodiments or aspects;

FIG. 5 shows a user interface for causing a gift card amount to be transferred according to some non-limiting embodiments or aspects;

FIG. 6 shows a user interface for entering transferee information according to some non-limiting embodiments or aspects;

FIG. 7 shows a system for transferring a gift card amount to a second user according to some non-limiting embodiments or aspects;

FIG. 8 shows a user interface for selling a gift card amount according to some non-limiting embodiments or aspects;

FIG. 9 shows a user interface for buying a gift card amount according to some non-limiting embodiments or aspects;

FIG. 10 shows a user interface displaying WGC cash available to a user in an electronic gift card wallet according to some non-limiting embodiments or aspects;

FIG. 11 shows a system including a plurality of merchants communicating with a WGC system to form a WGC merchant community according to some non-limiting embodiments or aspects;

FIG. 12 shows a system for transferring an amount from a user's electronic gift card wallet account to another user account according to some non-limiting embodiments or aspects; and

FIG. 13 shows a method for processing a gift card according to some non-limiting embodiments or aspects.

### DETAILED DESCRIPTION

For purposes of the description hereinafter, the terms “end,” “upper,” “lower,” “right,” “left,” “vertical,” “horizontal,” “top,” “bottom,” “lateral,” “longitudinal,” and derivatives thereof shall relate to the disclosure as it is oriented in the drawing figures. However, it is to be understood that the disclosure may assume various alternative variations and step sequences, except where expressly specified to the contrary. It is also to be understood that the specific devices and processes illustrated in the attached drawings, and described in the following specification, are simply exemplary embodiments or aspects of the disclosure. Hence, specific dimensions and other physical characteristics related to the embodiments or aspects disclosed herein are not to be considered as limiting.

No aspect, component, element, structure, act, step, function, instruction, and/or the like used herein should be construed as critical or essential unless explicitly described as such. Also, as used herein, the articles “a” and “an” are intended to include one or more items and may be used interchangeably with “one or more” and “at least one.” Furthermore, as used herein, the term “set” is intended to include one or more items (e.g., related items, unrelated items, a combination of related and unrelated items, etc.) and may be used interchangeably with “one or more” or “at least one.” Where only one item is intended, the term “one” or similar language is used. Also, as used herein, the terms “has,” “have,” “having,” or the like are intended to be open-ended terms. Further, the phrase “based on” is intended to mean “based at least partially on” unless explicitly stated otherwise.

The term “account data,” as used herein, refers to any data concerning one or more accounts for one or more users. Account data may include, for example, one or more account identifiers, user identifiers, transaction histories, balances, credit limits, issuer institution identifiers, and/or the like.

As used herein, the term “account identifier” may include one or more types of identifiers associated with a user account (e.g., a PAN, a primary account number, a card number, a payment card number, a token, and/or the like). In some non-limiting embodiments, an issuer institution may provide an account identifier (e.g., a PAN, a token, and/or the like) to a user that uniquely identifies one or more accounts associated with that user. The account identifier may be embodied on a payment device (e.g., a portable payment instrument, a payment card, a credit card, a debit card, and/or the like) and/or may be electronic information communicated to the user that the user may use for electronic payments. In some non-limiting embodiments, the account identifier may be an original account identifier, where the original account identifier was provided to a user at the creation of the account associated with the account identifier. In some non-limiting embodiments, the account identifier may be an account identifier (e.g., a supplemental account identifier) that is provided to a user after the original account identifier was provided to the user. For example, if the original account identifier is forgotten, stolen, and/or the like, a supplemental account identifier may be provided to the user. In some non-limiting embodiments, an account identifier may be directly or indirectly associated with an issuer institution such that an account identifier may be a token that maps to a PAN or other type of identifier. Account identifiers may be alphanumeric, any combination of characters and/or symbols, and/or the like. An issuer institution may be associated with a bank identification number (BIN) that uniquely identifies the issuer institution.

As used herein, the terms “communication” and “communicate” may refer to the reception, receipt, transmission, transfer, provision, and/or the like, of information (e.g., data, signals, messages, instructions, commands, and/or the like). For one unit (e.g., a device, a system, a component of a device or system, combinations thereof, and/or the like) to be in communication with another unit means that the one unit is able to directly or indirectly receive information from and/or transmit information to the other unit. This may refer to a direct or indirect connection (e.g., a direct communication connection, an indirect communication connection, and/or the like) that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit (e.g., a third unit located between the first unit and the second unit) processes information received from the first unit and communicates the processed information to the second unit. In some non-limiting embodiments or aspects, a message may refer to a network packet (e.g., a data packet and/or the like) that includes data. It will be appreciated that numerous other arrangements are possible.

As used herein, the term “computing device” may refer to one or more electronic devices that are configured to directly or indirectly communicate with or over one or more networks. The computing device may be a mobile device. As an example, a mobile device may include a cellular phone (e.g., a smartphone or standard cellular phone), a portable computer, a wearable device (e.g., watches, glasses, lenses, clothing, and/or the like), a personal digital assistant (PDA), and/or other like devices. The computing device may not be a mobile device, such as a desktop computer. Furthermore, the term “computer” may refer to any computing device that includes the necessary components to receive, process, and output data, and normally includes a display, a processor, a memory, an input device, and a network interface. An “application” or “application program interface” (API) refers to computer code or other data sorted on a computer-readable medium that may be executed by a processor to facilitate the interaction between software components, such as a client-side front-end and/or server-side back-end for receiving data from the client. An “interface” refers to a generated display, such as one or more graphical user interfaces (GUIs) with which a user may interact, either directly or indirectly (e.g., through a keyboard, mouse, etc.).

As used herein, the term “mobile device” may refer to one or more portable electronic devices configured to communicate with one or more networks. As an example, a mobile device may include a cellular phone (e.g., a smartphone or standard cellular phone), a portable computer (e.g., a tablet computer, a laptop computer, etc.), a wearable device (e.g., a watch, pair of glasses, lens, clothing, and/or the like), a PDA, and/or other like devices. The term “client device,” as used herein, refers to any electronic device that is configured to communicate with one or more servers or remote devices and/or systems. A client device may include a mobile device, a network-enabled appliance (e.g., a network-enabled television, refrigerator, thermostat, and/or the like), a computer, a POS system, and/or any other device or system capable of communicating with a network.

As used herein, the terms “electronic wallet” and “electronic wallet application” refer to one or more electronic devices and/or software applications configured to initiate and/or conduct payment transactions. For example, an electronic wallet may include a mobile device executing an electronic wallet application, and may further include server-side software and/or databases for maintaining and providing transaction data to the mobile device. An “electronic wallet provider” may include an entity that provides and/or maintains an electronic wallet for a customer, such as Google Pay®, Android Pay®, Apple Pay®, Samsung Pay®, and/or other like electronic payment systems. In some non-limiting examples, an issuer bank may be an electronic wallet provider.

As used herein, the term “gift card” (e.g., a gift certificate, a gift voucher, a gift token, and/or the like) may include a card (e.g., a physical card) issued by an entity, such as a merchant (e.g., a retailer) or a financial institution (e.g., a bank), that is provided to a recipient (e.g., an individual), where the card is associated with an account having a prepaid amount of funds and that can be used as an alternative to cash for a payment transaction involving a merchant. In some instances, a non-expired gift card may be redeemable only during a payment transaction at a specified merchant location. Additionally, the gift card may be subject to an expiration date. Further, the gift card may be subject to fees that are amounts deducted from the account associated with the gift card by the entity that issued the gift card based on a time period from issuance of the gift card, based on a number of payment transactions involving the gift card, and/or the like. In some instances, a gift card may include a virtual gift card (e.g., a mobile gift card, an electronic gift card, an e-gift card, and/or the like) that can be provided to a recipient electronically. The virtual gift card may be provided to the recipient via a communication to a mobile device of the recipient, such as via an email and/or a short message service (SMS). As used herein, the term “gift card” will be used to refer to both physical gift cards and virtual gift cards.

As used herein, the term “issuer institution” may refer to one or more entities, such as a bank, that provide accounts to users for conducting transactions (e.g., payment transactions), such as initiating credit and/or debit payments. For example, an issuer institution may provide an account identifier, such as a PAN, to a user that uniquely identifies one or more accounts associated with that user. The account identifier may be embodied on a portable financial device, such as a physical financial instrument, e.g., a payment card, and/or may be electronic and used for electronic payments. The term “issuer system” refers to one or more computer systems, computing devices, software applications, and/or the like operated by or on behalf of an issuer institution, such as a server computer executing one or more software applications. For example, an issuer system may include one or more authorization servers for authorizing a transaction, one or more authentication servers for authenticating a transaction, and/or one or more databases of account data. An issuer system may include a separate or integrated issuer authentication system, such as an Access Control Server (ACS), for authenticating online transactions. An issuer institution may be associated with a bank identification number (BIN) or other unique identifier that uniquely identifies it among other issuer institutions.

As used herein, the term “merchant” may refer to an individual or entity that provides goods and/or services, or access to goods and/or services, to users (e.g., users) based on a transaction (e.g., a payment transaction). The term “merchant system” may refer to one or more computer systems, computing devices, and/or software applications operated by or on behalf of a merchant, such as a server computer executing one or more software applications. A “point-of-sale (POS) system,” as used herein, may refer to one or more computers and/or peripheral devices used by a merchant to engage in payment transactions with users, including one or more card readers, near-field communication (NFC) receivers, RFID receivers, and/or other contactless transceivers or receivers, contact-based receivers, payment terminals, computers, servers, input devices, and/or other like devices that can be used to initiate a payment transaction. A POS system may be part of a merchant system. A merchant system may also include a merchant plug-in for facilitating online, Internet-based transactions through a merchant webpage or software application. A merchant plug-in may include software that runs on a merchant server or is hosted by a third-party for facilitating such online transactions.

As used herein, the term “payment device” may refer to a portable financial device, an electronic payment device, a payment card (e.g., a credit or debit card), a gift card, a smartcard, smart media, a payroll card, a healthcare card, a wrist band, a machine-readable medium containing account information, a keychain device or fob, an RFID transponder, a retailer discount or loyalty card, a cellular phone, an electronic wallet mobile application, a personal digital assistant (PDA), a pager, a security card, a computer, an access card, a wireless terminal, a transponder, and/or the like. In some non-limiting embodiments or aspects, the portable financial device may include volatile or non-volatile memory to store information (e.g., an account identifier, a name of the account holder, and/or the like).

As used herein, the term “server” may refer to or include one or more computing devices that are operated by or facilitate communication and processing for multiple parties in a network environment, such as the Internet, although it will be appreciated that communication may be facilitated over one or more public or private network environments and that various other arrangements are possible. Further, multiple computing devices (e.g., servers, point-of-sale (POS) devices, mobile devices, etc.) directly or indirectly communicating in the network environment may constitute a “system.” As used herein, the term “server” or “processor” may refer to one or more devices that provide a functionality to one or more devices (e.g., one or more client devices) via a network (e.g., a public network, a private network, the Internet, and/or the like). For example, a server may include one or more computing devices. As used herein, the term “system” may refer to one or more devices, such as one or more processors, servers, client devices, computing devices that include software applications, and/or the like. In some non-limiting embodiments or aspects, reference to “a server” or “a processor,” as used herein, may refer to a previously-recited server and/or processor that is recited as performing a previous step or function, a different server and/or processor, and/or a combination of servers and/or processors. For example, as used in the specification and the claims, a first server and/or a first processor that is recited as performing a first step or function may refer to the same or different server and/or a processor recited as performing a second step or function.

As used herein, the term “transaction service provider” may refer to an entity that receives transaction authorization requests from merchants or other entities and provides guarantees of payment, in some cases through an agreement between the transaction service provider and an issuer institution. For example, a transaction service provider may include a payment network such as Visa® or any other entity that processes transactions. The term “transaction processing system” may refer to one or more computer systems operated by or on behalf of a transaction service provider, such as a transaction processing server executing one or more software applications. A transaction processing server may include one or more processors and, in some non-limiting embodiments, may be operated by or on behalf of a transaction service provider.

As used herein, the term “user interface” or “graphical user interface” refers to a generated display, such as one or more graphical user interfaces (GUIs) with which a user may interact, either directly or indirectly (e.g., through a keyboard, mouse, touchscreen, etc.).

Non-limiting embodiments or aspects of the present disclosure are directed to a method, system, and computer program product for processing a gift card. Non-limiting embodiments or aspects enable a user to avoid at least a portion of a gift card balance from being lost by a user based on the gift card not having been redeemed by the expiration date of the gift card. An amount from an expired gift card may be transferred to an electronic gift card wallet account, such as a portion of an electronic gift card wallet that allows the cash value from certain expired gift cards to be used, transferred, and the like even after the expiration date. The transfer to the electronic gift card wallet account may be effected upon a waste-less gift card (WGC) system determining that an amount remains on the gift card after the expiration date of the gift card. Non-limiting embodiments or aspects enable a user to spend the cash value associated with the expired gift card and stored in the electronic gift card wallet account at certain merchants. Non-limiting embodiments or aspects enable a user to transfer the cash value associated with the expired gift card and stored in the electronic gift card wallet account to another account of the user, such as a user's bank account. Such features enable the user to more flexibly use their gift card. Non-limiting embodiments or aspects include a WGC merchant community which includes a plurality of merchants cooperating to enable a user to more flexibly use their gift card after the expiration date. The user may spend the cash value associated with the expired gift card and stored in the electronic gift card wallet account at a merchant within the WGC community. Non-limiting embodiments or aspects include an electronic gift card wallet that enables a user to better control features of their gift card, such as by enabling the user to transfer the gift card to another user, spend the gift card, sell a WGC gift card, buy a WGC gift card, redeem their gift card by initiating a payment transaction using their gift card, view active gift cards, and the like.

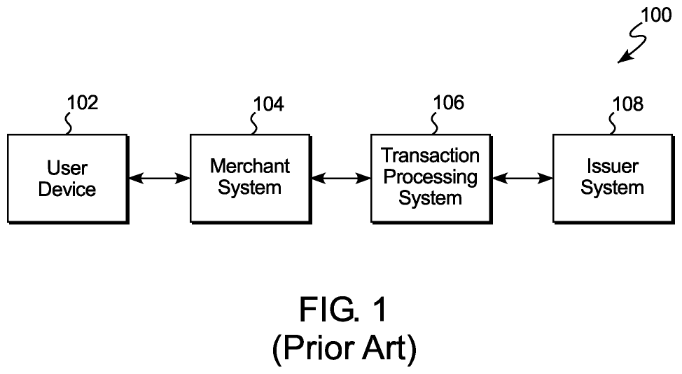

Referring to FIG. 1, an existing system 100 for processing a gift card is shown. According to the system 100, a payment transaction involving using a gift card for at least a portion of the transaction amount includes a user device 102 communicating with the merchant system 104 operated by or on behalf of a merchant to initiate the payment transaction between the user and the merchant system 104. The user device 102 may include a computing device having a gift card (e.g., virtual gift card) stored thereon or may include the physical gift card itself. In this way, the user presents the gift card to the merchant system 104 (e.g., a merchant POS system) to apply at least a portion of the gift card toward at least a portion of the payment transaction.

The gift card processed according to existing systems includes an expiration date, after which the amount remaining at the time of the expiration date is not capable of being redeemed with the merchant or with any other merchant or capable of being used in any other way (e.g., amount transferred to an electronic wallet or other user account, and the like).

To process the transaction using the gift card, the merchant system 104 communicates a transaction request to a transaction processing system 106 operated by or on behalf of a transaction service provider including gift card data associated with the gift card. The gift card data may include card account number, expiration date, pin number, amount available, desired amount to use, and/or other information for processing the payment transaction using the gift card. The transaction processing system 106 may communicate an authorization request to an issuer system 108 operated by or on behalf of an issuer (e.g., issuer of the gift card) including at least a portion of the gift card data to cause the issuer system 108 to make an authorization decision associated with the payment transaction. The authorization decision may be to approve the payment transaction, decline the payment transaction, or approve the payment transaction in part. The issuer system 108 may communicate an authorization including the authorization decision to the transaction processing system 106. The transaction processing system 106 may communicate a transaction response to the merchant system 104 including the authorization decision.

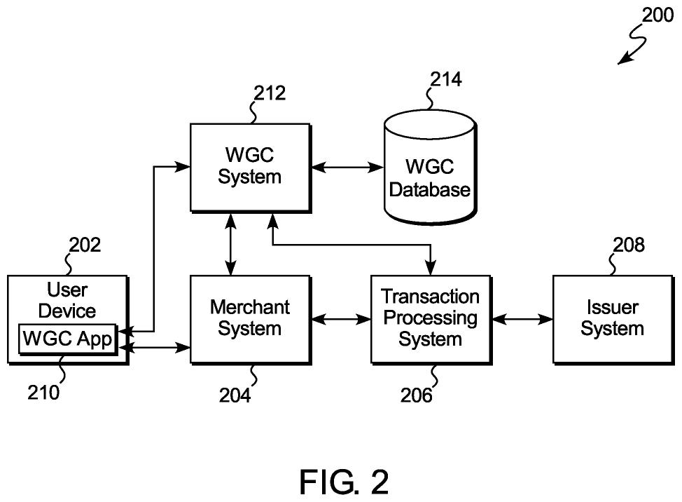

Referring to FIG. 2, a system 200 for processing a gift card according to some non-limiting embodiments or aspects is shown. The system 200 may include a user device 202 associated with a user. The user device 202 may include a computing device. The user device 202 may be in communication with a WGC system 212 configured to execute a WGC program for processing WGC gift cards. The WGC system may be operated by or on behalf of a merchant, transaction service provider, issuer, or other entity. The user device 202 may communicate with the WGC system 212 via a WGC application (e.g., a mobile application) 210 on the user's user device 202. Each user registering a WGC gift card with the WGC system 212 may have a WGC user account with which the user may control certain aspects of the WGC gift card as hereinafter described. The WGC user account may be accessed by the user through the WGC app 210 downloaded by the user on the user device 202, and/or the user may access the WGC user account through other suitable methods, such as by logging into the WGC user account through a website associated with the WGC system 212 upon creating a user account. The WGC user account accessible through the WGC application 210 and/or other means (e.g., online portal) is also referred to herein as the WGC gift card wallet.

The WGC system 212 may enable the user to control certain aspects of the WGC gift card. Non-limiting examples include the user registering a WGC gift card with the WGC system 212, viewing data associated with active and/or inactive WGC gift cards registered with the WGC system 212, initiate a payment transaction using a registered WGC gift card, transfer a registered WGC gift card to a transferee, sell a registered WGC gift card, buy a WGC gift card registered in the WGC system 212 by another, initiate a payment transaction using accumulated WGC cash, transfer accumulated WGC cash to a transferee and/or another account of the user, and the like. Each of the above examples will be described in more detail herein.

With continued reference to FIG. 2, the system 200 may further include a WGC database 214. The WGC database 214 may store data associated with the WGC system 212. The WGC database 214 may store data associated with the WGC program, such as program rules, merchant data associated with merchants participating in the WGC program and which make up the WGC merchant community, and the like. The WGC database 214 may store data associated with WGC user accounts, such as user data (user name, contact information, login data (e.g., username, password) user device data, user payment device data (e.g., PANs), user account data (e.g., external bank accounts or other financial accounts), registered WGC gift card data (e.g., gift card identifier, gift card amount, gift card expiration data, gift card merchant, gift card PIN, and the like), payment transaction history, WGC transaction history (e.g., a history of actions taken by the user associated with the WGC system 212), data associated with accumulated WGC cash, and the like). The WGC database 214 may store other data for execution of the WGC program.

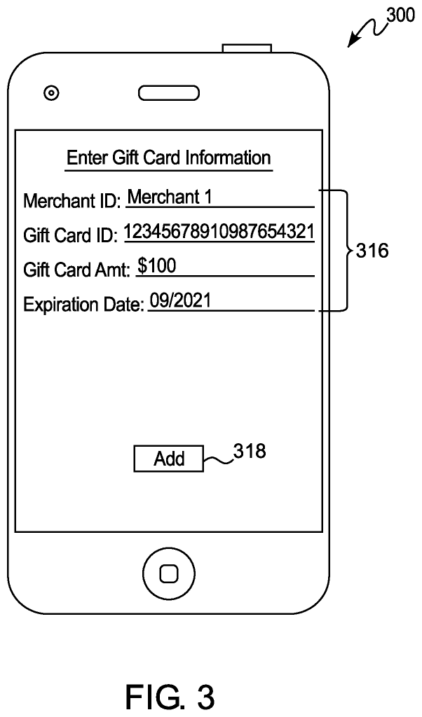

Referring to FIGS. 2 and 3, a gift card may be registered with the WGC system 212 for association with a WGC user account, such that the gift card is a WGC gift card. As used herein, a “WGC gift card” refers to a gift card registered with the WGC system 212 and associated with a WGC user account. The WGC gift card may be a gift card redeemable at a single merchant (e.g., a Walmart® gift card), redeemable at a predetermined group of merchants (e.g., a SIMON Giftcard®), a gift card redeemable at any merchant accepting electronic credit or debit payment transactions of an issuer of the gift card (e.g., Visa® gift card), and the like. A gift card may be registered with the WGC system 212 in a number of ways.

Registering a gift card with the WGC system 212 may include the WGC system 212 receiving a registration request to register the gift card with the registration request including a user identifier associated with the gift card user. The user identifier may identify the purchaser of the gift card if the gift card is to be used by the purchaser, or the user identifier may identify a recipient who the purchaser intends to use the gift card or other downstream recipient of the gift card, such that the WGC system 212 associates the gift card with the correct WGC user account. The user identifier may identify with which WGC user account the gift card is to be associated. In response to the registration request, the WGC system 212 may register the gift card with the WGC user account as a WGC gift card having a WGC gift card amount and an expiration date.

Referring to FIG. 3, a user may register a gift card with the WGC system 212 (see FIG. 2) by entering gift card data associated with a gift card into their WGC user account (e.g., such as using the WGC app 210). The user may be the purchaser of the gift card or a recipient of the gift card from the purchaser (directly or indirectly). FIG. 3 shows a non-limiting example of a user interface 300 in which a user may enter gift card data 316 in order to register a gift card with the WGC system 212. The gift card data 316 may include a merchant identifier (e.g., merchant name), a gift card identifier (e.g., gift card PAN), a gift card amount, a gift card expiration date, a gift card PIN number, and/or other data associated with the gift card. The user interface 300 may include a selectable option 318 to enable a user to submit the registration request to register the gift card with the WGC system 212 upon the relevant gift card data 316 being entered. The user may register the gift card with the WGC system after purchasing the gift card, whether it be a physical card or a virtual gift card, from a merchant. The registered gift card data may be stored in the WGC database 214 to associate the gift card with the WGC user account.

A user may register a gift card with the WGC system 212 using gift card image data taken by the user device 202. This may include the user taking a picture of the gift card with an image capturing device (e.g., a camera integrated into a smartphone) as the registration request, such that the WGC system 212 can automatically determine the gift card data 316 for registering the gift card with the WGC system 212 based on the image data. Other methods of registering a purchased gift card with the WGC system 212 such that the gift card is associated with a WGC user account may be used.

Referring again to FIG. 2, in some non-limiting embodiments or aspects, the gift card may be automatically registered with the WGC system 212 during purchase of the gift card by the user. The user may initiate a payment transaction with the merchant system 204 to purchase a gift card. During processing of the payment transaction for the gift card, the merchant system 204 may communicate the registration request to the WGC system 212 to cause the WGC system 212 to register the gift card to associate the gift card with the correct WGC user account. In some non-limiting embodiments or aspects, the transaction processing system 206 and/or the issuer system 208 may communicate the registration request to the WGC system 212 during processing of the payment transaction for the gift card. In some non-limiting embodiments or aspects, the user device 202 may communicate the registration request to the WGC system 212 during processing of the payment transaction for the gift card. In this way, a gift card may be automatically registered with the WGC system 212 at the time the gift card is purchased by the user. The user may initiate the transaction for the gift card using the WGC app 210 (or otherwise from the WGC user account) to cause the gift card to be automatically registered with the WGC system 212 at the time the gift card is purchased by the user. The user may use a payment device associated with the WGC gift card wallet (e.g., a credit and/or debit card whose data has been stored in the WGC gift card wallet) and/or may use WGC cash to purchase the gift card through the WGC gift card wallet.

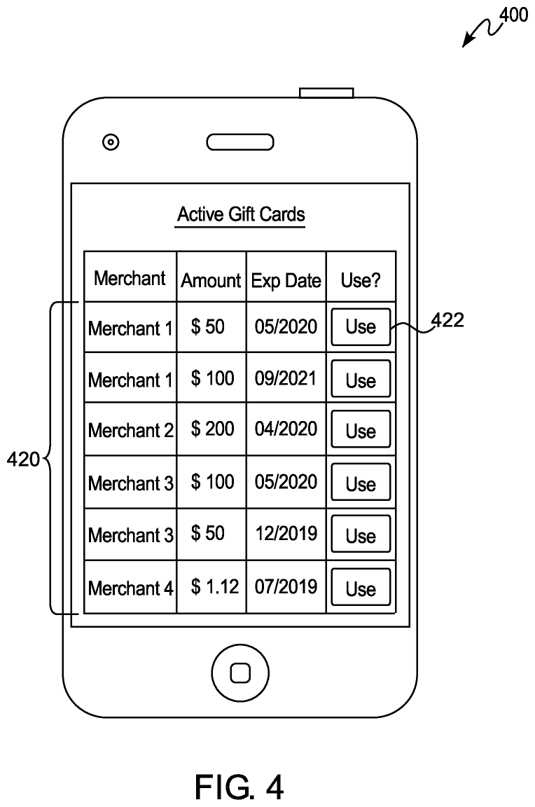

Referring to FIG. 4, the user device 202 may communicate with the WGC system 212 to display on the user device 202 the active (non-expired) and/or inactive (expired) WGC gift cards associated with the WGC user account. A user interface 400 may display WGC gift card data 420 associated with the WGC user account. The WGC gift card data 420 may include the merchant with which the WGC gift card is associated, an initial amount and/or remaining amount on the WGC gift card, the expiration date of the WGC gift card, and/or any of the other previously described gift card data.

Referring to FIGS. 2 and 4, the user interface 400 may include a selectable option 422 which enables a user to initiate a payment transactions using a WGC gift card associated with the WGC user account. Upon the selectable option 422 for the WGC gift card being selected, the user device 202 may communicate with the merchant system 204 to initiate a payment transaction using at least a portion the WGC gift card as the payment device for at least a portion of the transaction amount. The user may specify how much of the WGC gift card is to be used toward the payment transaction.

In some non-limiting embodiments or aspects, during and/or after the payment transaction initiated using the WGC gift card, the WGC system 212 may communicate with at least one of the user device 202, the merchant system 204, the transaction processing system 206, and/or the issuer system 208 to monitor redemption of the gift card amount. The WGC system 212 may determine the amount on the WGC gift card being used and/or the amount of the WGC gift card being redeemed through the payment transaction to determine an updated amount remaining on the WGC gift card during and/or after processing of the payment transaction. The WGC system 212 may store the updated amount remaining the WGC gift card in the WGC database 214 and may store other data associated with the payment transaction in the WGC database 214. The updated amount remaining on the WGC gift card may be displayed on the user interface 400.

In some non-limiting embodiments or aspects, the WGC system 212 may monitor redemption of the WGC gift card amount by communicating with a gift card database (not shown) that stores data associated with the gift card (such as a database maintained by the issuer of the gift card). The WGC system 212 may periodically communicate with the database to monitor redemption of the WGC gift card. It will be appreciated that the WGC gift card may be used to initiate payment transactions without being initiated from the WGC user account. As a non-limiting example, a WGC gift card may be physically presented to the merchant system 204. The WGC system 212 may monitor such initiated payment transactions by the merchant system 204, the transaction processing system 206, and/or the issuer system 208 identifying that the gift card presented is a WGC gift card and communicate with the WGC system 212 during and/or after the payment transaction. The WGC system 212 may monitor such initiated payment transactions by periodically communicating with the gift card database to determine the updated WGC gift card amount.

The WGC system 212 may monitor redemption of the WGC gift card amount between registration of the gift card and the expiration date of the gift card to determine whether at least a portion of the WGC gift card amount still remains by the expiration date.

Monitoring redemption of the WGC gift card amount may include the WGC system 212 determining at some time before the expiration date whether at least a portion of the gift card amount has not been redeemed. The WGC system 212 may communicate a reminder message to the user device 202 based on the identifier associated with the gift card user. The reminder message may identify a WGC gift card that has not been fully redeemed and/or the expiration date associated with that WGC gift card. Reminder messages may be periodically communicated to the user device 202 to remind the user of the expiration date of the WGC gift card. The reminder message may be communicated to the user device 202 at any rate and/or at any period of time prior to the expiration date of the WGC gift card. Messages may be sent by the WGC system 212 to the user device 202 for other relevant activities, such as the upon the expiration of a WGC gift card, upon an amount associated with an expired WGC gift card being transferred into WGC cash (to the WGC wallet account), upon a WGC gift card being used for a payment transaction or being completely used (having zero balance), upon a WGC gift card being bought, sold, or transferred, and the like.

The WGC system 212 may monitor payment transactions initiated using the WGC gift card and/or the WGC gift card amount as previously described. The WGC system 212 may also monitor the previously described certain aspects of the WGC gift card for which the WGC system 212 enables the user to control.

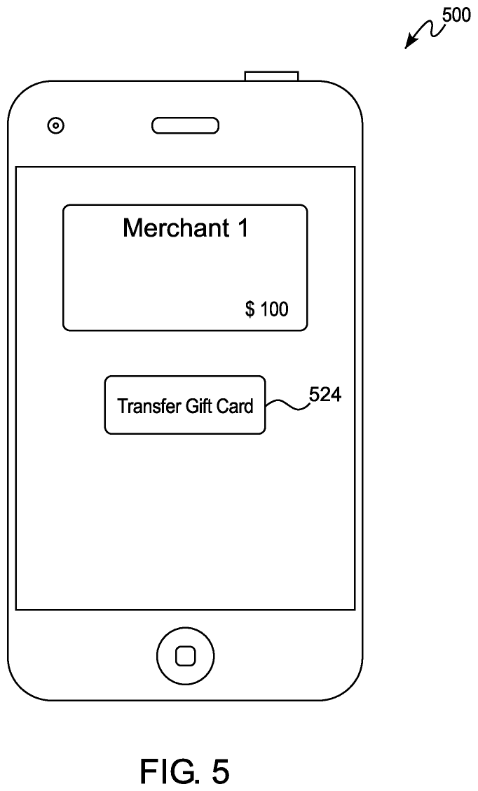

Referring to FIGS. 5-7, a user may transfer at least a portion of the WGC gift card amount to another user (a transferee). FIG. 5 shows a user interface 500 which enables a user to transfer at least a portion of the WGC gift card amount to a transferee. The user interface 500 may display the WGC gift card the user may wish to transfer to a transferee. At least a portion of the WGC gift card data may be displayed, such as the merchant name, the amount remaining on the gift card, the expiration date of the gift card, and the like. The user interface 500 may include a selectable option 524 which enables the user to initiate transfer of at least a portion of the WGC gift card amount to a transferee.

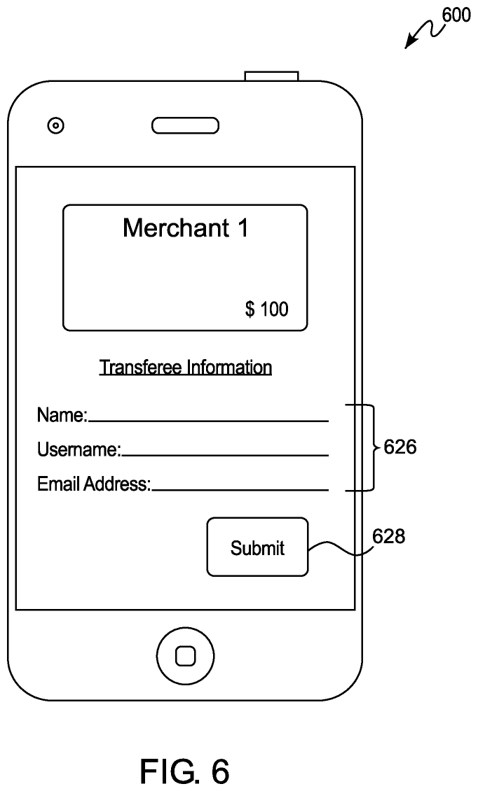

FIG. 6 shows a user interface 600 for transferring at least a portion of the WGC gift card to a transferee. The user interface 600 may include transferee data 626 to allow the user to specify the transferee to receive at least a portion of the WGC gift card. The transferee data 626 may include any data which allows the WGC system 212 to identify the transferee and/or the WGC user account of the transferee. Non-limiting examples of transferee data include transferee name, transferee WGC account data (e.g., user name, account identifier, and the like), transferee contact information, and the like. The user may specify an amount of the WGC gift card to be transferred to the transferee. The amount to be transferred may include an entire amount of the WGC gift card or a lesser portion than the entire amount of the WGC gift card. The WGC gift card being transferred may be an unused gift card having the original WGC gift card amount or may be a partially used WGC gift card having less than the original WGC gift card amount. The user interface 600 may include a selectable option 628 to enable the user to initiate the transfer of the portion of the WGC gift card amount to the transferee.

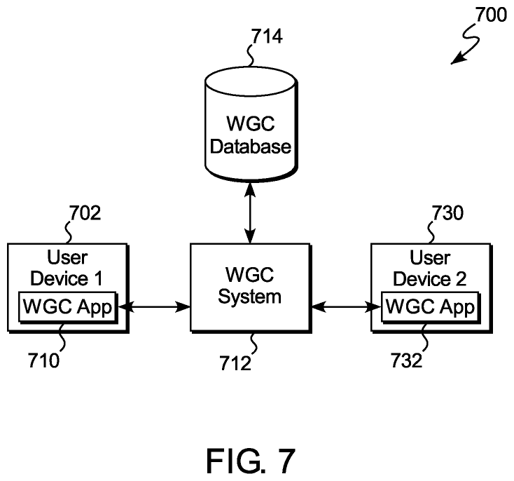

FIG. 7 shows a system 700 for transferring a portion of the WGC gift card amount to the transferee according to some non-limiting embodiments or aspects. In the non-limiting system 700 shown in FIG. 7, user device 1 702 and WGC app 710 correspond to the user device and WGC app of the user (transferor), and user device 2 730 and WGC app 732 correspond to the user device and WGC app of the transferee. The user may initiate the transfer of the portion of the WGC gift card amount to the transferee by the user device 1 702 communicating a gift card transfer request to the WGC system 712. The WGC system 712 may communicate with the user device 2 730 to transfer the portion of the WGC gift card amount to the transferee. The gift card transfer request may cause the identifier associate with the gift card being transferred to be updated to indicate that the gift card is associated with the WGC user account of the transferee (and no longer the WGC user account of the user-transferor). The WGC system 712 may accordingly communicate with the WGC database 714 to update the status of the gift card being transferred (including updating the WGC user accounts of the transferor and/or the transferee).

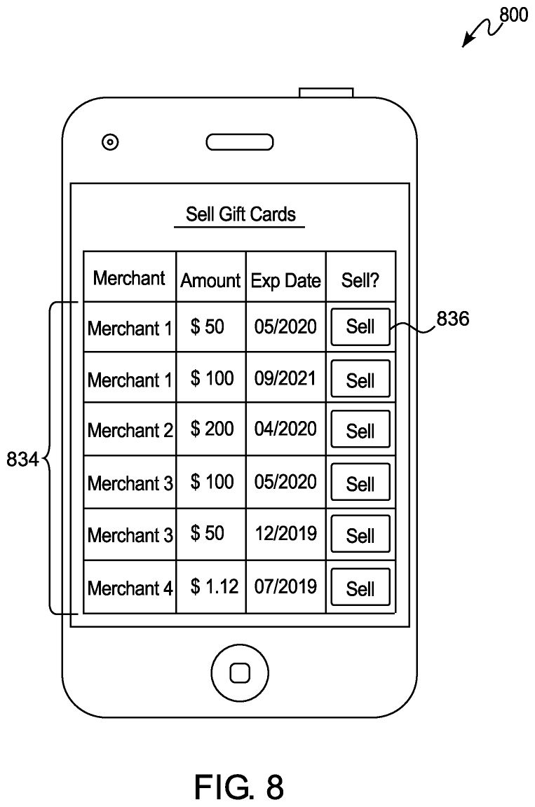

Referring to FIG. 8, a user may sell a WGC gift card from their WGC user account. A user interface 800 may display the active WGC gift cards from the user's WGC user account. The user interface 800 may display WGC gift card data 834 associated with the WGC gift cards in the user's WGC account. The WGC gift card data 834 may include the same data as the WGC gift card data 420 described in connection with FIG. 4. The user interface 800 may include a selectable option 836 that enables the user to initiate the sale of a WGC gift card. The user may specify the portion of the WGC gift card amount to be sold. For example, on a WGC gift card having a $50 value, the user may sell the entire gift card amount ($50) or some lesser value of that gift card (e.g., $25). The user may specify the price of the gift card being sold, which may be the same as the value of the gift card amount for sale or some lesser amount. In this way, the user may control the WGC gift card using the WGC system 212 to transfer (as previously described) the WGC gift card to a buyer in response to the WGC gift card being sold to the buyer.

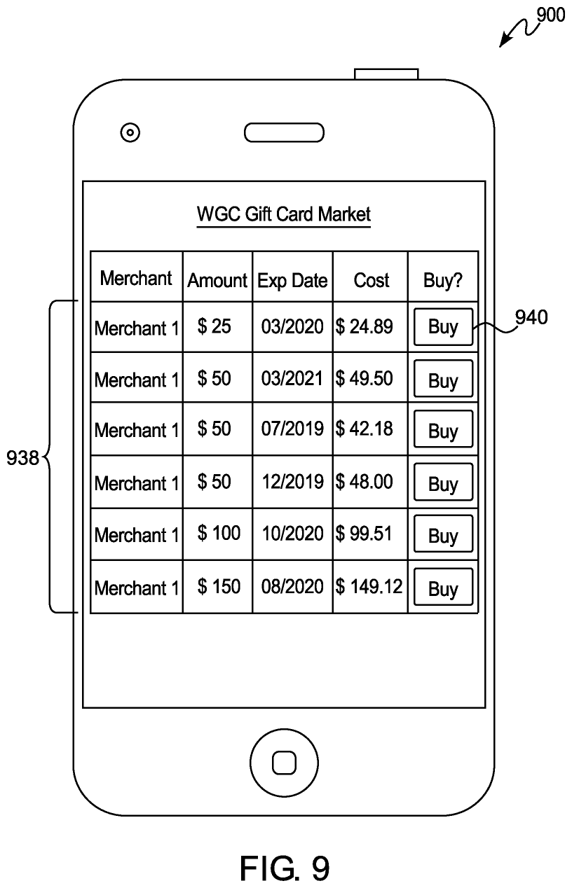

Referring to FIG. 9, a user may buy a WGC gift card from another user using the WGC system 212. A user interface 900 may display a WGC gift card marketplace which displays a list of WGC gift cards for sale by other users. The list may include WGC gift card data 938 associated with the WGC gift cards for sale. The WGC gift card data 938 may include a merchant associated with the WGC gift card, amount of the WGC gift card, expiration date of the WGC gift card, price to purchase the WGC gift card, seller identifier, seller ratings, and the like. The user interface 900 may include a selectable option 940 to enable a user to initiate purchase of a WGC gift card for sale by another user, such that the WGC gift card being purchased is transferred (as previously described) to the purchasing user.

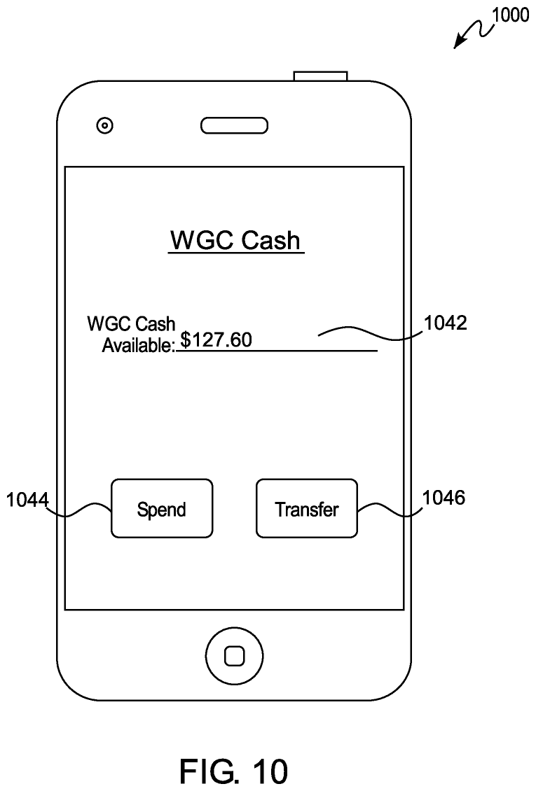

Referring to FIGS. 2 and 10, as previously described, the WGC system 212 may monitor redemption of the WGC gift card amount of a WGC gift card by at least determining whether at least a portion of the WGC gift card amount has not been redeemed by the expiration date. This may include determining upon the WGC gift card expiring a WGC gift card amount associated with the WGC gift card not redeemed by the expiration date.

In response to determining that at least a portion of the WGC gift card amount has not been redeemed by the expiration date, the WGC system 212 may automatically cause at least a portion of the WGC gift card amount to be transferred to an account in an electronic gift card wallet of the user based on the identifier associated gift card user. The account may contain funds (WGC cash) previously associated with a WGC gift card that, once the WGC gift cards expired, the WGC gift card amount associated therewith may be transferred into the WGC wallet account as WGC cash available for use by the user. This allows a user to use an amount associated with a gift card even after the gift card expired, unlike conventional gift cards which no longer have an amount useable by the user after the expiration date.

In some non-limiting embodiments or aspects, the WGC gift card having an amount being transferred to the account as WGC cash after expiration of the WGC gift card may be associated with a merchant that is associated with a merchant community having a plurality of merchants. In some non-limiting embodiments or aspects, the entire remaining amount of the WGC gift card amount may be transferred to the account as WGC cash, while in other non-limiting embodiments, some lesser amount of the entire amount of the remaining WGC gift card amount may be transferred to the account was WGC cash (such as based on a surcharge assessed by at least one of the gift card issuer, the merchant community, and the like).

FIG. 10 shows a non-limiting example of a user interface 1000 displaying account information associated with an account including WGC cash. The user interface 1000 may display an amount 1042 of WGC cash available to the user. The user interface 1000 may include a selectable option 1044 to enable a user to initiate a transaction (spend) using at least a portion of the available WGC cash. The user interface 1000 may include a selectable option 1046 to enable a user to initiate a transfer of at least a portion of the available WGC cash.

Referring to FIGS. 2 and 10, a user may select selectable option 1044 of the user interface 1000 to initiate a payment transaction with a merchant using at least a portion of the WGC cash as the payment device. The user device 202 may communicate a transaction request to the merchant system 204 to initiate the payment transaction and indicate that WGC cash in the WGC user account is to be applied to at least a portion of the amount of the payment transaction. The merchant system 204 may communicate with the WGC system 212 during processing of the payment transaction to apply the WGC cash from the account toward the payment transaction amount. The WGC system 212 may communicate with the user device 202 and/or the WGC database 214 to update the amount of available WGC cash in the account upon processing of the payment transaction using the WGC cash.

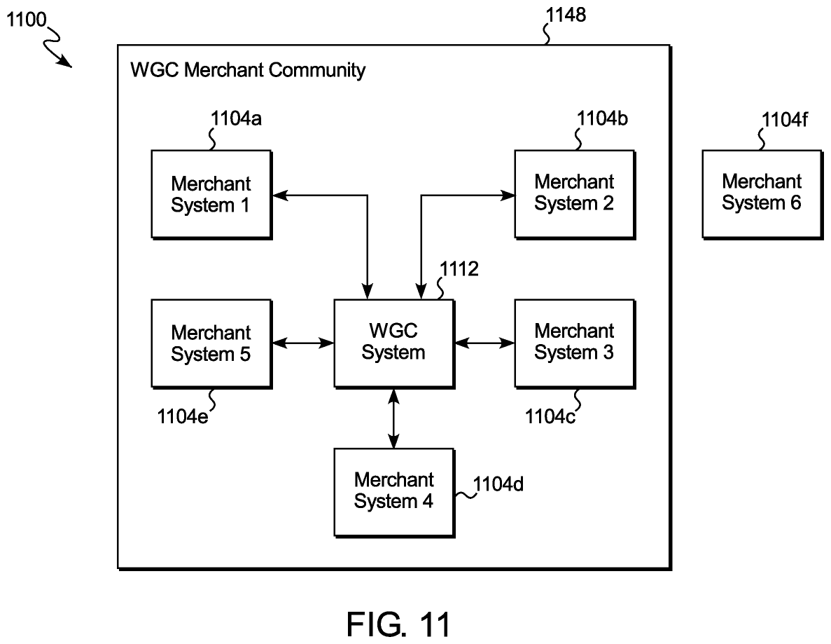

Referring to FIG. 11, a system 1100 including a plurality of merchant systems 1104a-e operated by or on behalf of a plurality of merchants communicating with a WGC system 1112 to form a WGC merchant community 1148 is shown. The WGC merchant community 1148 may include a plurality of different merchants which all communicate with the WGC system 1112 to cooperate as the WGC merchant community 1148. Certain merchant systems 1104f operated by or on behalf of merchants may be outside of the WGC merchant community 1148 (not be a part of the WGC merchant community 1148), and may not be in communication with the WGC system 1112.

Referring to FIGS. 2 and 11, in some non-limiting embodiments, the transaction request from the user device 202 to initiate a payment transaction with a merchant using at least a portion of the WGC cash as the payment device may be communicated to a merchant system 1104a-e within the WGC merchant community 1148. In some non-limiting embodiments or aspects, the user may be restricted to initiating transactions using the WGC cash with only merchant systems 1104a-e within the WGC merchant community 1148 (and not merchant system 6 1104f). The merchant with which the user initiates a payment transaction using the WGC cash may be the same merchant associated with the WGC gift card before the amount was transferred to the account as WGC cash upon expiration thereof, or a different merchant from the WGC merchant community 1148 than the merchant associated with the WGC gift card before the amount was transferred to the account as WGC cash upon expiration thereof.

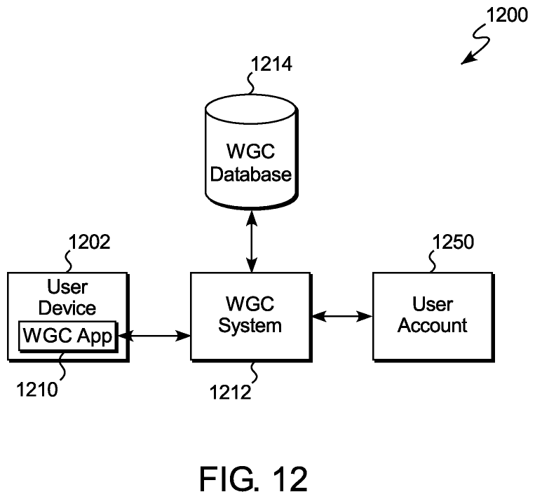

Referring to FIGS. 10 and 12, a user may select selectable option 1046 of the user interface 1000 to initiate a transfer request of at least a portion of the WGC cash. The transfer request may cause transfer of at least a portion of the WGC cash to a second account. In some non-limiting embodiments or aspects, the second account may include an account of another user, including the bank or other financial account of another user or an WGC user account of another user with which WGC cash of the another user is associated. In some non-limiting embodiments or aspects the second account may include an account of the user (of the WGC account from which the transfer is made), including a bank or other financial account of the user.

Referring to FIG. 12, a system 1200 for transferring an amount from a user's electronic gift card wallet account to another account is shown. The user device 1202 of the user may communicate with the WGC system 1212 to transfer the WGC cash to a second account 1250. The WGC system 1212 may cause at least a portion of the WGC cash be transferred to the second account 1250. The WGC system 1212 may communicate with the WGC database 1214 to update the amount of WGC cash available to the user upon the transfer. The user may specify the amount of WGC cash to be transferred to the second account 1250 and/or identify the second account 1250 associated with the transfer.

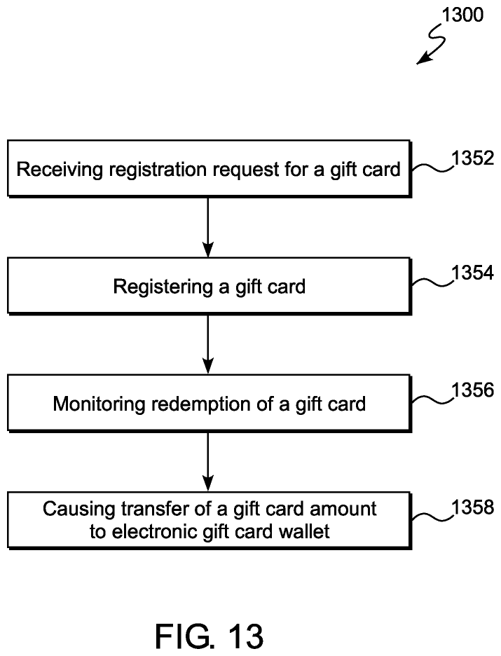

Referring to FIG. 13, a method 1300 for processing a WGC gift card according to some non-limiting embodiments or aspects is shown. At a step 1352, the WGC system may receive a registration request for registration of a gift card. The registration request may include an identifier associated with user. At a step 1354, in response to the registration request, the WGC system may register the gift card for the gift card amount. The gift card may have an expiration date.

With continued reference to FIG. 13, at a step 1356, the WGC system may monitor redemption of the gift card amount by at least determining whether at least a portion of the gift card amount has not been redeemed by the expiration date. At a step 1358, in response to determining that at least a portion of the gift card amount has not been redeemed by the expiration date, the WGC system may cause at least a portion of the gift card amount to be transferred to an account in an electronic gift card wallet associated with the user based on the identifier associated with the user.

In a further, non-limiting embodiment or aspect, a computer program product for processing a gift card includes at least one non-transitory computer readable medium including program instructions that, when executed by at least one processor, cause the at least one processor to execute one of the previously-described methods. The at least one processor may include the WGC system, the user device, the merchant system, the transaction processing system, and/or the issuer system.

Although the disclosure has been described in detail for the purpose of illustration based on what is currently considered to be the most practical and preferred embodiments, it is to be understood that such detail is solely for that purpose and that the disclosure is not limited to the disclosed embodiments, but, on the contrary, is intended to cover modifications and equivalent arrangements that are within the spirit and scope of the appended claims. For example, it is to be understood that the present disclosure contemplates that, to the extent possible, one or more features of any embodiment can be combined with one or more features of any other embodiment.

1. A method of processing a gift card, comprising:
receiving, with at least one processor, a registration request for registration of a gift card, the registration request comprising an identifier associated with at least one gift card user;
in response to the registration request, registering, with at least one processor, a gift card for a gift card amount, the gift card comprising an expiration date;
monitoring, with at least one processor, redemption of the gift card amount by at least determining whether at least a portion of the gift card amount has not been redeemed by the expiration date; and
in response to determining that at least a portion of the gift card amount has not been redeemed by the expiration date, causing, with at least one processor, at least a portion of the gift card amount to be transferred to an account in an electronic gift card wallet associated with the at least one gift card user based on the identifier associated with the at least one gift card user.

2. The method of claim 1, further comprising:
receiving, with at least one processor, a gift card transfer request, wherein the gift card transfer request causes the identifier associated with the at least one gift card user to be updated.

3. The method of claim 1, wherein the gift card is associated with a first merchant, wherein the first merchant is associated with a merchant community comprising a plurality of merchants.

4. The method of claim 3, further comprising:
receiving, with at least one processor, a transaction request for a transaction associated with a transaction amount, wherein the transaction request is initiated by the electronic gift card wallet, wherein the transaction request causes application of at least a portion of the gift card amount transferred to the electronic gift card wallet account toward the transaction amount.

5. The method of claim 4, wherein the transaction involves a merchant of the plurality of merchants from the merchant community.

6. The method of claim 5, wherein the transaction involves a merchant different from the first merchant.

7. The method of claim 1, wherein monitoring redemption of the gift card amount further comprises:
determining at some time before the expiration date whether at least a portion of the gift card amount has not been redeemed; and
in response to determining that at least a portion of the gift card amount has not been redeemed, communicating a reminder message to a computing device associated with the at least one gift card user based on the identifier associated with the at least one gift card user.

8. The method of claim 1, wherein the at least one gift card user is at least one of a purchaser of the gift card and a recipient of the gift card.

9. The method of claim 1, further comprising:
receiving, with at least one processor, a transfer request, wherein the transfer request is initiated by the electronic gift card wallet, wherein the transfer request causes transfer of at least a portion of the gift card amount transferred to the electronic gift card wallet account to a bank account associated with the at least one gift card user.

10. The method of claim 1, wherein the registration request is initiated by the electronic gift card wallet.

11. A system for processing a gift card, comprising at least one processor programmed or configured to:
receive a registration request for registration of a gift card, the registration request comprising an identifier associated with at least one gift card user;
in response to the registration request, register a gift card for a gift card amount, the gift card comprising an expiration date;
monitor redemption of the gift card amount by at least determining whether at least a portion of the gift card amount has not been redeemed by the expiration date; and
in response to determining that at least a portion of the gift card amount has not been redeemed by the expiration date, cause at least a portion of the gift card amount to be transferred to an account in an electronic gift card wallet associated with the at least one gift card user based on the identifier associated with the at least one gift card user.

12. The system of claim 11, wherein the at least one processor is further programmed or configured to:
receive a gift card transfer request, wherein the gift card transfer request causes the identifier associated with the at least one gift card user to be updated.

13. The system of claim 11, wherein the gift card is associated with a first merchant, wherein the first merchant is associated with a merchant community comprising a plurality of merchants.

14. The system of claim 13, wherein the at least one processor is further programmed or configured to:
receive a transaction request for a transaction associated with a transaction amount, wherein the transaction request is initiated by the electronic gift card wallet, wherein the transaction request causes application of at least a portion of the gift card amount transferred to the electronic gift card wallet account toward the transaction amount.

15. The system of claim 14, wherein the transaction involves a merchant of the plurality of merchants from the merchant community.

16. A computer program product for processing a gift card, the computer program product comprising at least one non-transitory computer-readable medium including one or more instructions that, when executed by at least one processor, cause the at least one processor to:
receive a registration request for registration of a gift card, the registration request comprising an identifier associated with at least one gift card user;
in response to the registration request, register a gift card for a gift card amount, the gift card comprising an expiration date;
monitor redemption of the gift card amount by at least determining whether at least a portion of the gift card amount has not been redeemed by the expiration date; and
in response to determining that at least a portion of the gift card amount has not been redeemed by the expiration date, cause at least a portion of the gift card amount to be transferred to an electronic gift card wallet associated with the at least one gift card user based on the identifier associated with the at least one gift card user.

17. The computer program product of claim 16, wherein the one or more instructions cause the at least one processor to:
receive a gift card transfer request, wherein the gift card transfer request causes the identifier associated with the at least one gift card user to be updated.

18. The computer program product of claim 16, wherein the gift card is associated with a first merchant, wherein the first merchant is associated with a merchant community comprising a plurality of merchants.

19. The computer program product of claim 18, wherein the one or more instructions cause the at least one processor to:
receive a transaction request for a transaction associated with a transaction amount, wherein the transaction request is initiated by the electronic gift card wallet, wherein the transaction request causes application of at least a portion of the gift card amount transferred to the electronic gift card wallet account toward the transaction amount.

20. The computer program product of claim 19, wherein the transaction involves a merchant of the plurality of merchants from the merchant community.
